(19) United States
(12) Patent Application Publication
(10) Pub. No.: US 2013/0246831 A1
(43) Pub. Date: Sep. 19, 2013

(54) SELECTION DEVICE, SELECTION METHOD AND INFORMATION PROCESSING DEVICE

(71) Applicant: FUJITSU LIMITED, Kawasaki-shi (JP)

(72) Inventor: Takahiro YUZAWA, Kawasaki (JP)

(73) Assignee: FUJITSU LIMITED, Kawasaki-shi (JP)

(21) Appl. No.: 13/718,642

(22) Filed: Dec. 18, 2012

(30) Foreign Application Priority Data
Mar. 13, 2012 (JP) 2012-056302

(51) Int. Cl. G06F 1/12

(52) U.S. Cl. CPC G06F 1/12
USPC 713/400

(57) ABSTRACT

A selection device includes an interface connected to at least a clock signal line and a chip select signal line among output lines of a first device, a plurality of interfaces respectively connected to chip select signal lines of a plurality of second devices each operated in synchronization with a clock signal of the first device, a measuring unit that measures a clock frequency of the first device, and a selecting unit that, according to the clock frequency of the first device measured by the measuring unit, selects a chip select signal line connected to one of the plurality of second devices, and outputs a chip select signal from the first device to the selected chip select signal line.

### CROSS-REFERENCE TO RELATED APPLICATION

This application is based upon and claims the benefit of priority of the prior Japanese Patent Application No. 2012-056302, filed on Mar. 13, 2012 in the Japanese Patent Office, the entire contents of which are incorporated herein by reference.

### FIELD

The present invention relates to a selection device and a selection method for selecting one device from a plurality of devices.

### BACKGROUND

Examples of the synchronous serial communication standards include SPI (Serial Peripheral Interface). In an SPI configuration in which a plurality of slave devices are connected to one master device, the master device transmits a chip select signal to the slave devices to select one of the slave devices for communication with each of the slave devices.

FIG. 1 is a diagram illustrating an example of connection between one master device and a plurality of slave devices based on SPI. An SPI master device P50 has a plurality of chip select (CS) signal lines. The SPI master device P50 activates a chip select signal line connected to an SPI slave device which is to be in communication with the SPI master device P50, and the SPI master device P50 performs communication with the SPI slave device via a clock signal line (SCK) and data signal lines (SDI, SDO). The SPI slave device performs communication with the SPI master device P50 in synchronization with the clock from the SPI master device P50. In the following, an SPI master device is simply referred to as a master device. Further, an SPI slave device is simply referred to as a slave device. Further, one of the slave devices illustrated in FIG. 1 is represented as a slave device P51.

FIG. 2 illustrates an example of a time chart in the case where the master device P50 and the slave device P51 in FIG. 1 perform communication with each other. In FIG. 2, the horizontal axis represents time (t), and the vertical axis represents H (High) and L (Low) levels of each type of the signals.

The master device P50 asserts a chip select signal on a signal line CS1 connected to the slave device P51, and transmits data via the data signal line SDO. In FIG. 2, it is assumed that the chip select signal is active when it is at L level.

When the chip select signal CS1 is asserted, the slave device P51 receives the data from the master device P50 via the data signal line SDI. When the chip select signal CS1 is asserted, the slave device P51 transmits data via the data signal line SDO in synchronization with a clock signal SLK. The master device P50 receives the data from the slave device P51 via the data signal line SDI.

[Patent document 1] Japanese Patent Laid-Open No. 2006-304011

[Patent document 2] Japanese Patent Laid-Open No. 2005-196486

[Patent document 3] Japanese Patent Laid-Open No. 2008-186185

However, the connection based on SPI has the following problems. In the connection between the master device and the plurality of slave devices as illustrated in FIG. 1, the master device is provided with the chip select signal lines corresponding to the number of the slave devices. Further, the slave devices are installed at positions away from the master device in many cases. This results in a problem that, when the number of the slave devices is increased, the number of the signal lines between the master device and the slave devices is increased, so that the area occupied by hardware (hardware occupation area) is increased.

Further, for example, when the number of the slave devices is larger than the number of the chip select signal lines of the master device, a device for outputting the chip select signals is separately provided. Also, in this case, there arises a problem that the hardware occupation area is increased.

FIG. 3 is a diagram illustrating an example of connection in the case where the number of slave devices is larger than the number of chip select signal lines of a master device 60. In FIG. 3, the number of the chip select signal lines of the master device 60 is three, while four slave devices 61 to 64 are provided. For this reason, a signal output device 66, which outputs a chip select signal to the slave device 64, is connected to the master device by a signal line different from the chip select signal line. The chip select signal line of the slave device 64 is connected to the signal output device 66, and the slave device 64 receives the chip select signal from the signal output device 66. Therefore, the configuration illustrated in FIG. 3 has a problem that the hardware occupation area is increased due to the chip select signal line.

Further, the configuration illustrated in FIG. 3 has the following problems in addition to the increase in the hardware occupation area. In the example illustrated in FIG. 3, when the master device 60 performs communication with the slave device 64, the chip select signal is transmitted to the slave device 64 via the signal output device 66. For this reason, in addition to the time for outputting the chip select signal, overhead occurs for transmitting the chip select signal via the signal output device 66, which affects the speed of access to the slave device 64. Further, when the signal output device 66 is controlled by software, additional time is also requested for the master device 60 to access the signal output device 66, and hence overhead is further increased.

### SUMMARY

One aspect of the present invention is a selection device. The selection device includes an interface connected to at least a clock signal line and a chip select signal line among output lines of a first device, a plurality of interfaces respectively connected to chip select signal lines of a plurality of second devices each operated in synchronization with a clock signal of the first device, a measuring unit that measures a clock frequency of the first device, and a selecting unit that, according to the clock frequency of the first device measured by the measuring unit, selects a chip select signal line connected to one of the plurality of second devices, and outputs a chip select signal from the first device to the selected chip select signal line.

The object and advantage of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of connection between one master device and a plurality of slave devices based on SPI;

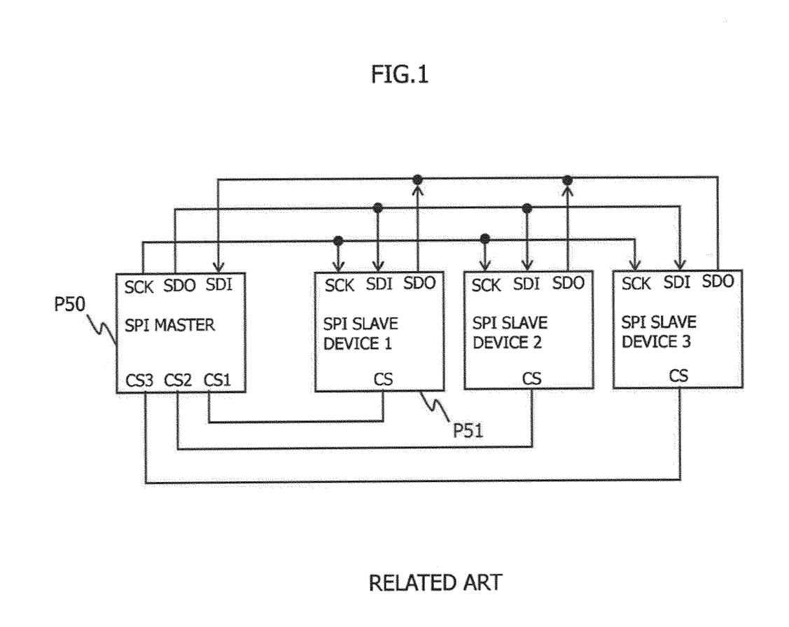

FIG. 2 illustrates an example of a time chart in the case where the master device performs communication with the slave device in FIG. 1;

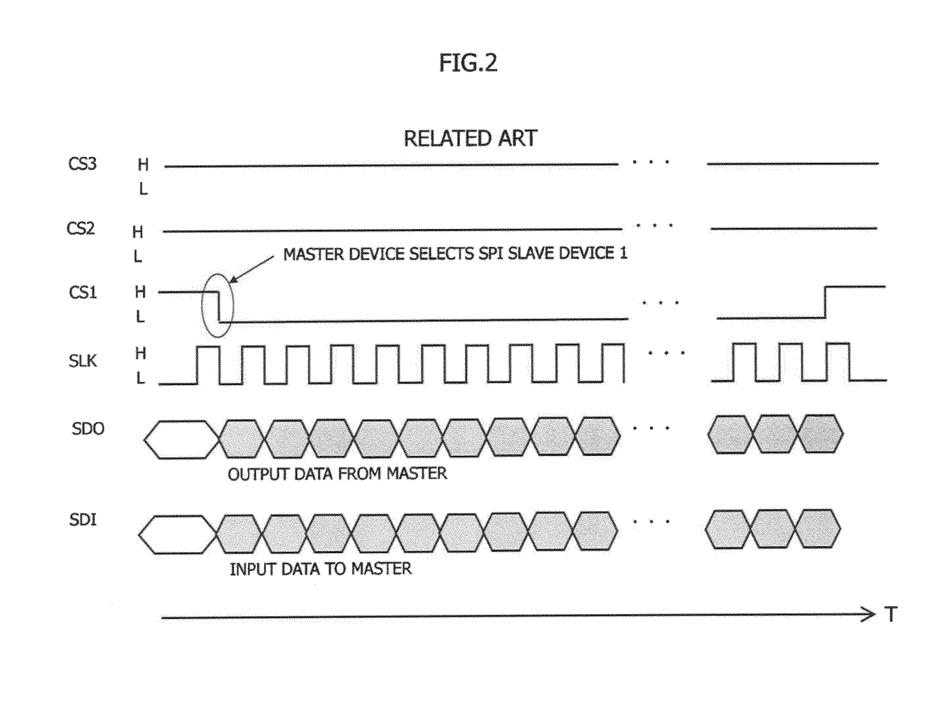

FIG. 3 is a diagram illustrating an example of connection in the case where the number of the slave devices is larger than the number of chip select signal lines of the master device;

FIG. 4 is a diagram illustrating an example of a configuration of an information processing system according to a first embodiment;

FIG. 5 is a diagram illustrating an example of a configuration of a slave CS control unit;

FIG. 6 illustrates an example of a time chart of the slave CS control unit;

FIG. 7 is a diagram illustrating ranges of count values, and chip select signal lines to be selected respectively in correspondence with the ranges of count values;

FIG. 8 illustrates a truth table for chip selection;

FIG. 9 illustrates an example of a flow chart of software processing of the master device;

FIG. 10 is a diagram illustrating a concrete example of the information processing system;

FIG. 11 illustrates an example of ranges of count values, which ranges are respectively assigned to the chip select signal lines in FIG. 10;

FIG. 12 illustrates an example of a truth table for chip selection in FIG. 10;

FIG. 13 illustrates an example of a time chart in the case where the master device performs communication with the slave device;

FIG. 14 is a diagram illustrating an example of a configuration of a slave CS control unit in a second embodiment;

FIG. 15 illustrates an example of ranges of count values, which ranges are assigned to chip select signal lines of an encoder circuit;

FIG. 16 illustrates an example of a truth table for chip selection.

### DESCRIPTION OF EMBODIMENTS

In the following, embodiments according to the present invention will be described with reference to the accompanying drawings. The following configurations of the embodiments are exemplary and should not be construed as limiting the scope of the invention.

### First Embodiment

In a first embodiment, a configuration of an information processing system, in which one master device is connected to a plurality of slave devices, includes a measuring unit which measures a clock frequency of a first device (the master device), and a selecting unit which selects one of a plurality of second devices (the slave devices) according to the clock frequency of the first device.

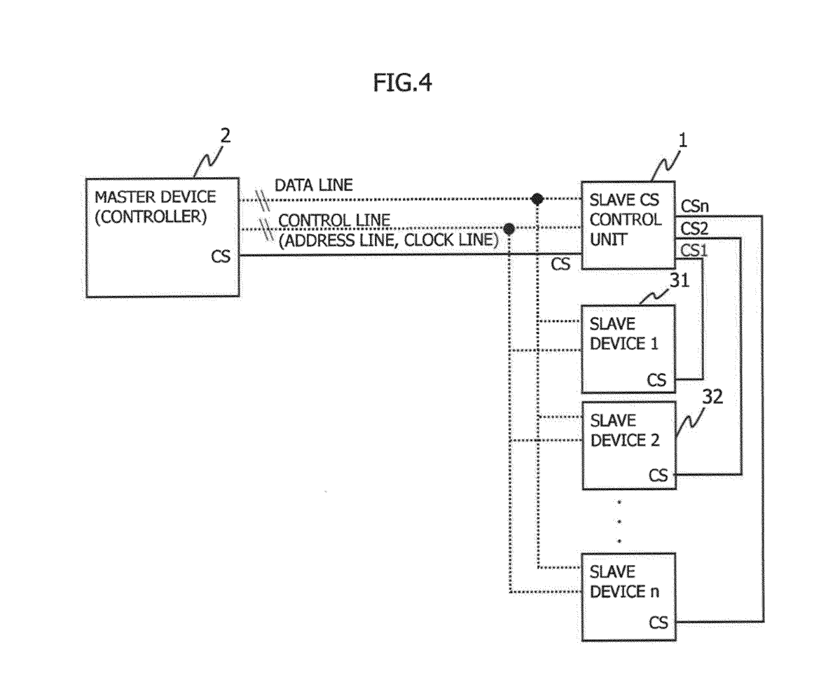

FIG. 4 is a diagram illustrating an example of the configuration of the information processing system according to the first embodiment. The information processing system includes a master device 2, a plurality of slave devices each operated in synchronization with a clock of the master device 2, and a slave CS control unit 1. In FIG. 4, an address line and a clock line are illustrated as one control line for convenience. The master device 2 is a processor, such as, for example, a controller, and a CPU (Central Processing Unit). The slave devices are devices, such as, for example, a controller of an auxiliary storage device, such as a ROM (Read Only Memory), a controller of a SW hub, various sensor chips, an interface chip of a portable recording medium driving device, and a network interface.

The master device 2, the slave CS control unit 1, and each of the slave devices are commonly connected to each other by data lines and control lines (a clock line and an address line). The CS line of the master device 2 is connected to the slave CS control unit 1. Each of the CS lines of the slave CS control unit 1 is connected to corresponding one of the slave devices.

The slave CS control unit 1 measures a clock frequency of the master device 2, and selects, according to the clock frequency, a slave device to which a CS signal is to be outputted. The slave CS control unit 1 includes a reference clock 12 (described below), and measures the clock frequency of the master device 2 by measuring the number of clock cycles of the reference clock 12, which are included in one clock cycle of the master device 2.

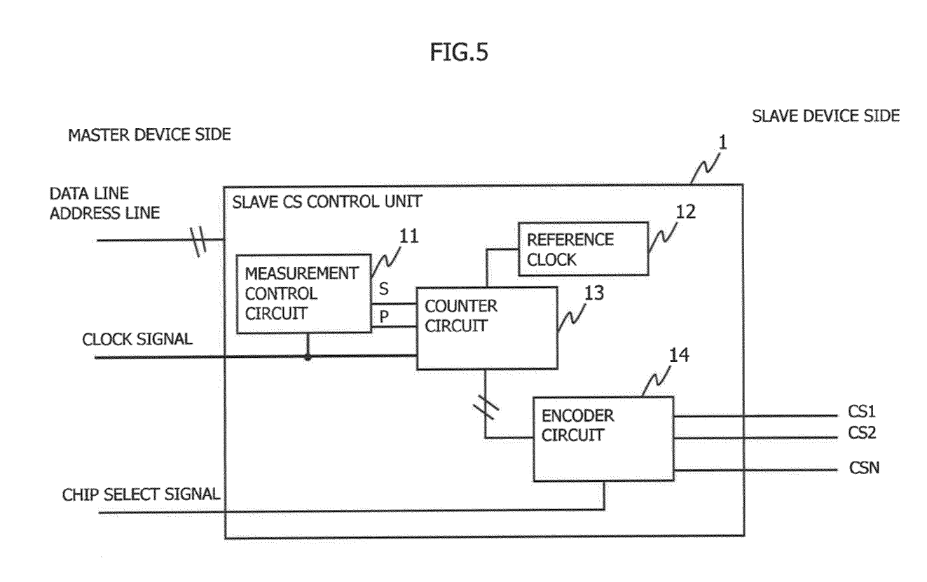

FIG. 5 is a diagram illustrating an example of a configuration of the slave CS control unit 1. The slave CS control unit 1 includes a measurement control circuit 11, a reference clock 12, a counter circuit 13, and an encoder circuit 14. Each of these circuits is an electric circuit or an electronic circuit. Although not illustrated in FIG. 5, the slave CS control unit 1 includes an interface to which at least the clock signal line and the chip select signal line of the master device 2 are connected, and an interface to which the chip select signal lines respectively connected to the slave devices are connected.

The reference clock 12 is a clock used for measuring the clock frequency of the master device 2. For this reason, the clock frequency of the reference clock 12 is set higher than the clock frequency of the master device 2.

The measurement control circuit 11 is a circuit which receives, as an input, the clock signal outputted from the master device 2, and which performs control for making the counter circuit 13 the start and end of the measurement of the clock signal outputted from the master device 2. A signal line S in FIG. 5 is a signal line for outputting a signal which instructs the start of the measurement (Start) of the clock signal. Further, a signal line P in FIG. 5 is a signal line for outputting a signal which instructs the end of the measurement (Pause) of the clock signal. The signal line S and the signal line P are connected to the counter circuit 13. However, a signal which instructs the start of the measurement of the clock signal and a signal which instructs the end of the measurement of the clock signal may be outputted by using one signal line.

The counter circuit 13 receives, as input signals, the signals which instruct the start and end of the measurement of the clock signal and which are outputted from the measurement control circuit 11, and measures the number of clock cycles of the reference clock 12, which are included in one clock cycle of the clock signal outputted from the master device 2. The count value of the number of clock cycles is outputted to the encoder circuit 14. The counter circuit 13 is an example of the “measuring unit”.

The encoder circuit 14 receives, as input signals, the measured value of the number of clock cycles measured by the counter circuit 13, and the chip select signal of the master device 2. The encoder circuit 14 selects a chip select signal line corresponding to the count value of the number of clock cycles, and outputs the chip select signal of the master device 2 through the selected chip select signal line. The encoder circuit 14 is an example of the “selecting unit”.

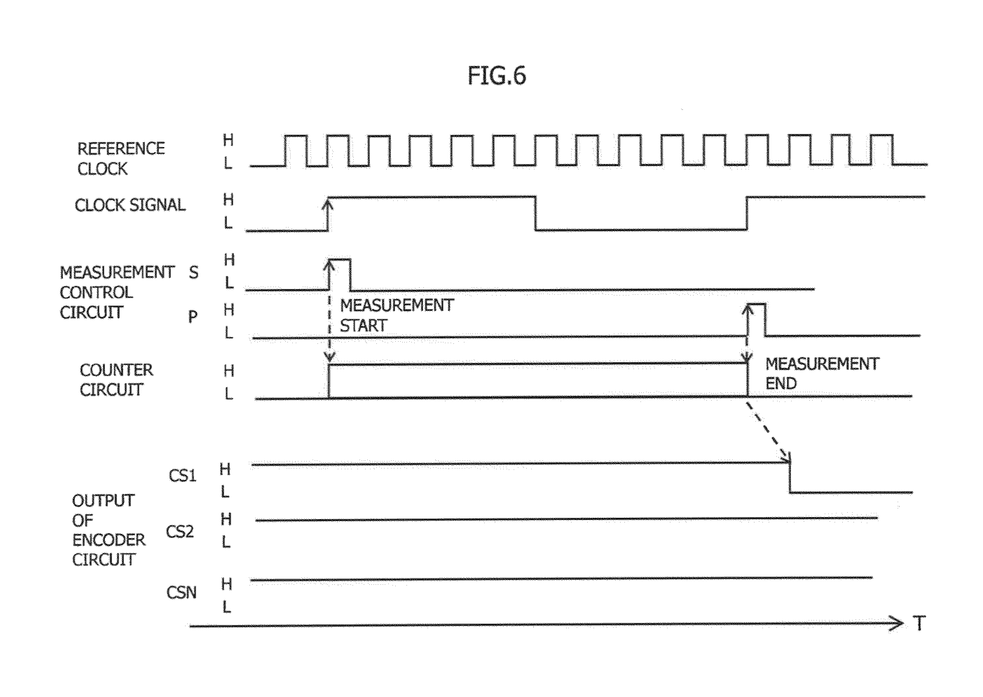

FIG. 6 illustrates an example of a time chart of the slave CS control unit 1. The measurement control circuit 11 detects a rising edge of the clock signal of the master device 2, and outputs a signal S which instructs the start of the measurement. When receiving, as an input signal, the signal S instructing the start of the measurement, the counter circuit 13 starts the counting of the reference clock 12. The measurement control circuit 11 detects the next rising edge of the clock signal of the master device 2, and outputs a signal P which instructs the end of the measurement. When receiving, as an input signal, the signal P instructing the end of the measurement, the counter circuit 13 ends the measurement of the reference clock. Thereby, the counter circuit 13 measures the number of clock cycles of the reference clock 12 which are included in one clock cycle of the master device 2. According to the count value, the encoder circuit 14 selects a chip select signal line, for example, a chip select signal line CS 1.

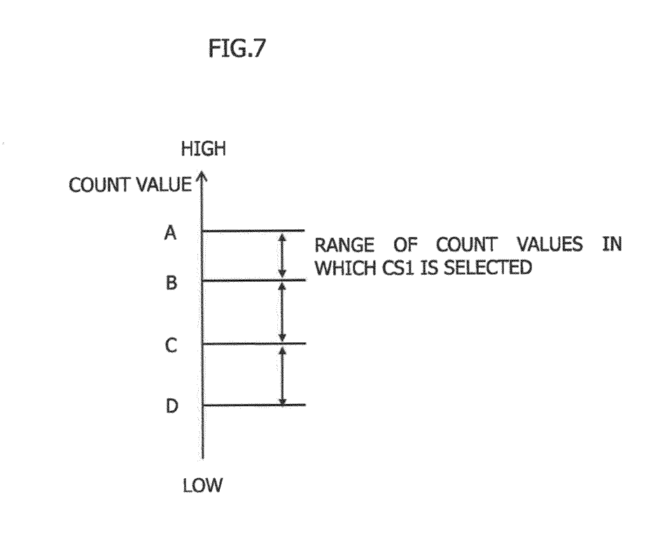

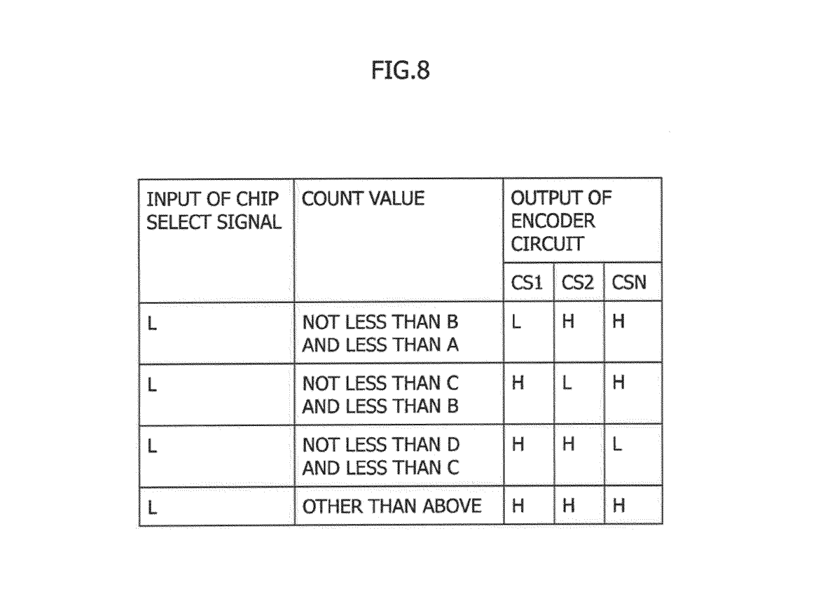

FIG. 7 is a diagram illustrating ranges of count values, and the chip select signal lines to be selected respectively in correspondence with the ranges of count values. FIG. 8 illustrates a truth table used for chip selection and held in the encoder circuit 14. The encoder circuit 14 holds therein the truth table, for example, as a logic circuit, and is operated based on the truth table. In the truth table, count values of the counter circuit 13 which correspond to the clock frequencies of the master device 2 are divided into a plurality of ranges, and the chip select signal lines to be selected respectively for the plurality of ranges are set. In the truth table of FIG. 8, for example, in the range of the count values from B to A, the chip select signal line CS1 is set to be selected. Note that, in the information processing system illustrated in FIG. 4, the chip select signal from the master device 2 and the chip select signal of the encoder circuit 14 (slave CS control unit 1) are active which they are at L level. However, the active level is not limited to L level.

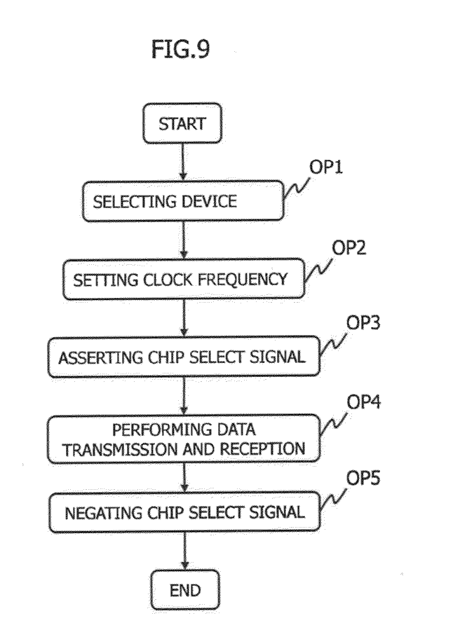

FIG. 9 illustrates an example of a flow chart of software processing of the master device 2. The flow chart illustrated in FIG. 9 is started when the master device 2 communicates with a slave device.

In OP1, the master device 2 selects a slave device as a communication partner. In OP2, the master device 2 sets the clock frequency thereof to a frequency corresponding to the operation frequency of the slave device selected as the communication partner. At this time, the slave CS control unit 1 measures the clock frequency of the master device 2, and selects a chip select signal line corresponding to the clock frequency.

In OP3, the master device 2 asserts the chip select signal. The chip select signal asserted by the master device 2 is transmitted from the slave CS control unit 1 to the selected chip select signal line.

In OP4, the master device 2 performs data transmission and reception to and from the slave device selected as the communication partner via the data signal line. In OP5, the master device 2 negates the chip select signal.

### CONCRETE EXAMPLE

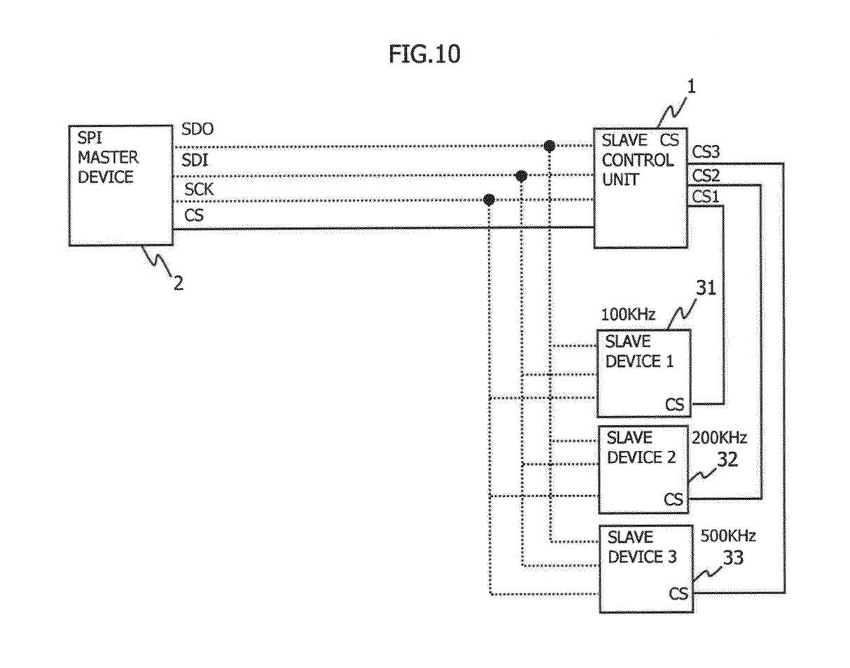

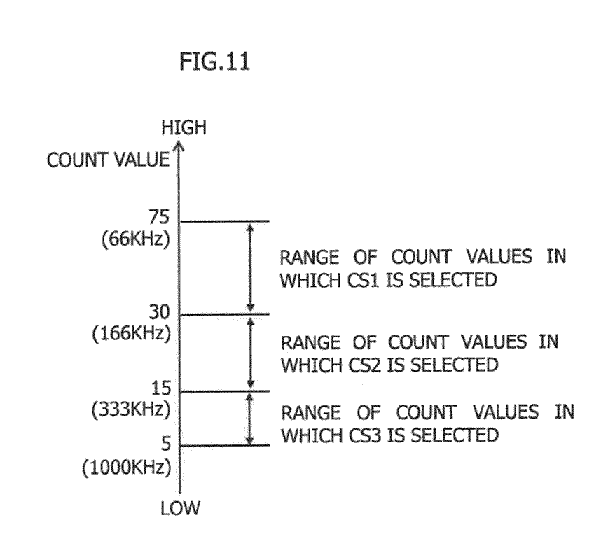

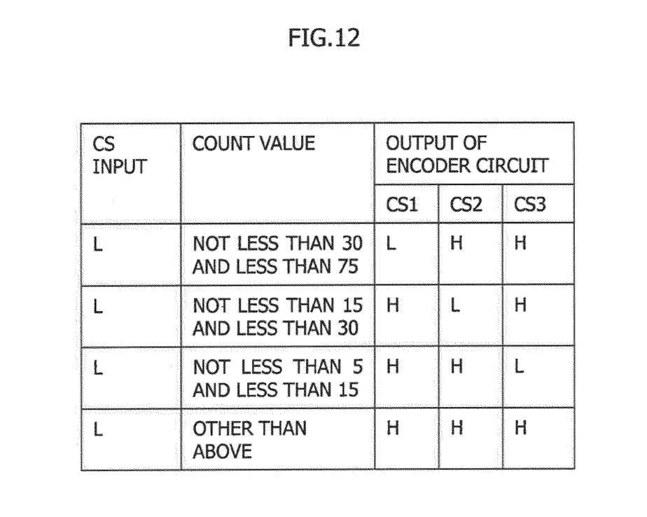

FIG. 10 is a diagram illustrating a concrete example of the information processing system. In FIG. 10, operation frequencies of slave devices 31, 32 and 33 are respectively set to 100 KHz, 200 KHz and 500 KHz. Further, the clock frequency of the reference clock 12 of the slave CS control unit 1 is set to 5 MHz. FIG. 11 illustrates an example of ranges of count values, which ranges are respectively assigned to the chip select signal lines in this case. FIG. 12 illustrates an example of a truth table used for chip selection and held in the encoder circuit 14 in this case.

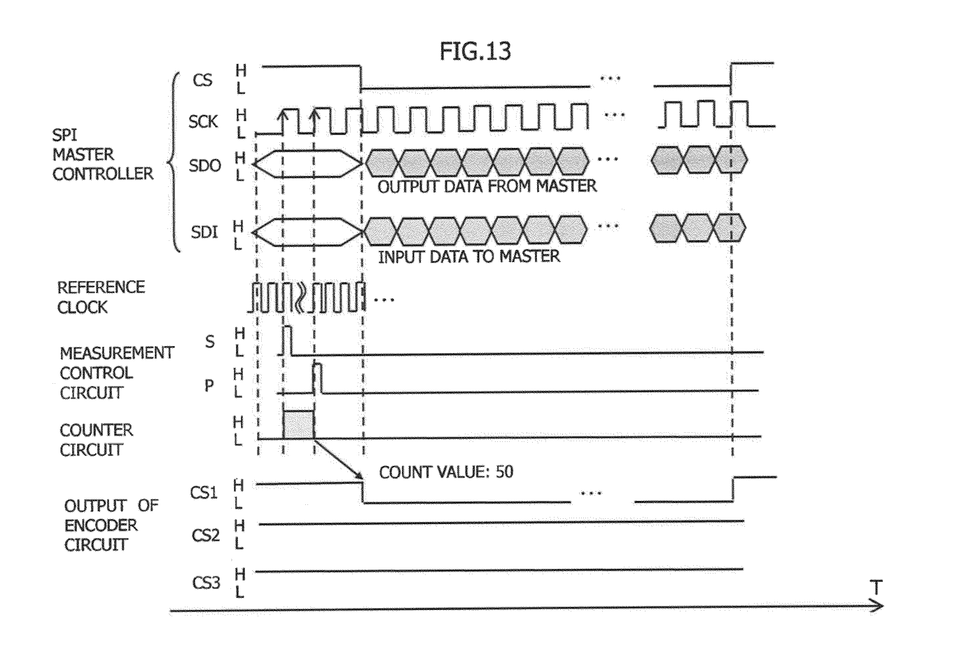

FIG. 13 illustrates an example of a time chart in the case where the master device 2 performs communication with the slave device 31. The master device 2 asserts the chip select signal after several clock cycles from the start of the clock supply, and then starts the data transmission. At this time, since the master device 2 performs communication with the slave device 31, the clock frequency of the master device 2 is set to 100 KHz.

The slave CS control unit 1 measures the clock frequency (100 KHz) of the master device 2 based on the reference clock 12 (clock frequency 5 MHz). Fifty clocks of the reference clock 12 are included in one clock cycle of the clock signal supplied from the master device 2, and hence the count value of the reference clock 12 in the counter circuit 13 becomes 50. When the chip select signal is asserted by the master device 2, the encoder circuit 14 selects the chip select signal CS1 according to the truth table illustrated in FIG. 12, and asserts the chip select signal on the chip select signal line CS1. Thereby, data transmission and reception between the master device 2 and the slave device 31 are enabled.

In the above, the case where data transmission and reception are performed between the master device 2 and the slave device 31 is described as an example. Also in the case where the master device 2 transmits data to each of the other slave devices, the clock frequency corresponding to the slave device is used, and the same method is performed.

Note that, even in the case where each of the slave devices is the same hardware device, the slave CS control unit 1 can be applied in such a manner that the operation frequencies of the slave devices are set to respectively correspond to different ranges of frequencies in which ranges the slave devices can be operated (for example, as illustrated in the truth table in FIG. 12 and FIG. 13).

### Operations and Effects of First Embodiment

In the first embodiment, the chip select signal line of the master device 2, and the chip select signal line of each of the slave devices are connected to the slave CS control unit 1. The slave CS control unit 1 measures the clock frequency of the master device 2, and selects a chip select signal line corresponding to the clock frequency. Thereby, it is possible to reduce the number of chip select signal lines which are to be respectively arranged between the master device 2 and the slave devices in correspondence with the slave devices. In many cases, the master device 2 and the slave device are installed at positions relatively away from each other. Therefore, when the number of the signal lines between the master device 2 and the respective slave devices is reduced, it is possible to reduce the hardware occupation area. Note that, in many cases, the slave CS control unit 1 and each of the slave devices are installed at positions which are closer to each other as compared with the distance between the master device 2 and each of the slave devices. For this reason, the hardware occupation area due to the chip select signal lines, each of which is provided between the slave CS control unit 1 and each of the slave devices, is reduced as compared with the hardware occupation area due to the same number of chip select signal lines each of which is provided between the master device 2 and each of the slave devices. With the disclosed the slave CS control unit 1, it is possible to reduce the hardware occupation area.

Further, even in the case where a slave device is additionally installed, the CS signal line of the slave device to be added may be connected to the slave CS control unit 1, and hence it is possible to reduce an increase in the signal lines between the master device 2 and the slave device.

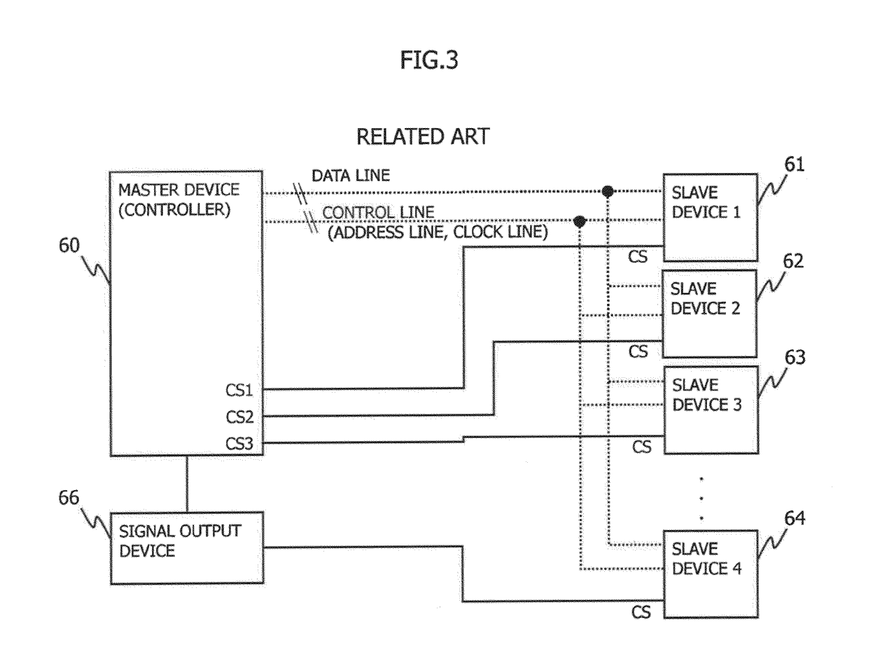

Further, conventionally, in the case where the number of slave devices is larger than the number of the CS signal lines of the master device, the signal output device 66 is separately connected to the master device 2 as illustrated in FIG. 3, and the CS line of the slave device is connected to the signal output device 66. In the case where communication is performed between the master device 60 and the slave device having the CS signal line connected to the signal output device 66, the CS signal is transmitted via the signal output device 66, and hence the time for chip select assertion is increased as compared with the case where communication is performed between the master device 60 and the slave device having the CS signal line connected to the master device 60. Examples of the periods of time requested when the CS is asserted via the signal output device 66 include a period of time requested for the master device 60 to access the signal output device 66, and a period of time requested for the signal output device 66 to convert the chip select signal. In the first embodiment, in the case where communication is performed between the master device 2 and each of the slave devices, the CS signal line is through the slave CS control unit 1, but the period of time requested for the processing in the slave CS control unit 1 is sufficiently shorter than the period of time requested for the processing to be performed in association with the signal output device 66, for example, illustrated in FIG. 3. This is because merely the chip select processing originally performed in the master device is performed in the slave CS control unit 1. That is, when the slave CS control unit 1 is provided, the processing in the master device 2 is simplified. Further, as illustrated, for example, in FIG. 6 and FIG. 13, the period of time requested for the processing in the slave CS control unit 1 is in the range of about one clock cycle to several clock cycles of the clock of the master device 2. The period of time requested for the processing to be performed in association with the signal output device is significantly larger than this period of time. Therefore, according to the first embodiment, even in the case where the number of the slave devices is larger than the number of the CS signal lines of the master device, communication between the master device and any of the slave devices can be performed with a shorter delay time.

### Second Embodiment

In the second embodiment, the truth table for chip selection is not fixedly provided, as hardware, in the encoder circuit 14 of the slave CS control unit 1, but is provided in a nonvolatile memory (ROM) provided in the slave CS control unit 1. Thereby, the truth table can be changed from the master device 2. Note that the description which overlaps with the first embodiment will be omitted.

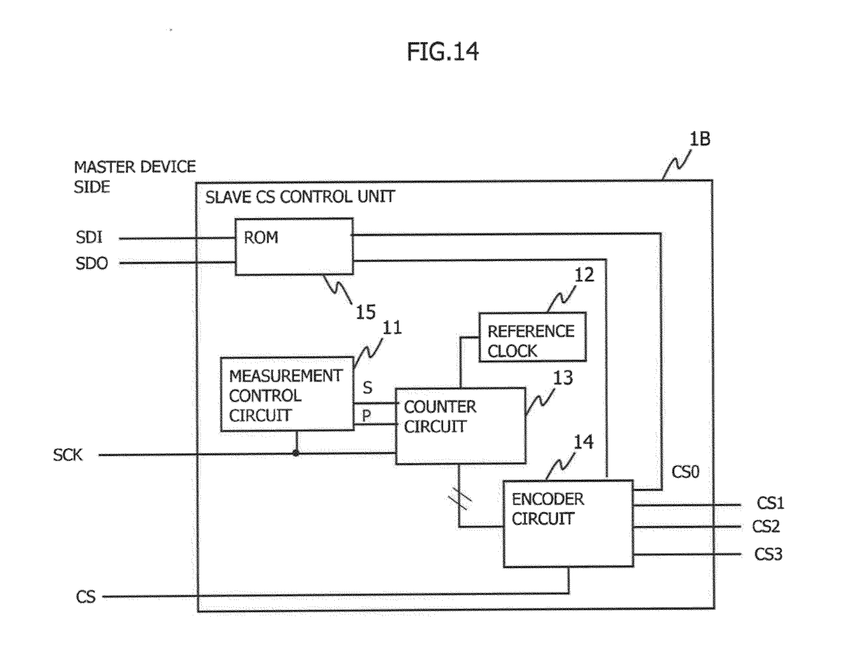

FIG. 14 is a diagram illustrating an example of a configuration of a slave CS control unit 1B in the second embodiment. The slave CS control unit 1B includes a ROM 15 in addition to the measurement control circuit 11, the reference clock 12, the counter circuit 13, and the encoder circuit 14. The ROM 15 stores, for example, the truth table for chip selection, and the encoder circuit 14 reads the truth table from the ROM 15, to set a register, a flip-flop, and the like in the encoder circuit 14. For example, the range of clock frequencies which is assigned to each of the chip select signal lines is held in the encoder circuit 14. When a count value is inputted from the counter circuit 13, the encoder circuit 14 asserts, according to the setting, a chip select signal line corresponding to the count value. However, instead of setting, in the encoder circuit 14, the truth table stored in the ROM 15, it may also be configured, for example, such that a comparator in the encoder circuit 14 compares the count value of the counter circuit 13 with a set value stored in the ROM 15, and such that a CS signal line is selected according to the comparison result in the comparator. In any of the configurations, the operations other than the operation for selecting the CS signal line by comparing the count value of the clock signal with the truth table or set values stored in the ROM 15 are the same as the operations in the first embodiment.

The data lines (SDI, SDO) of the ROM 15 are connected to the master device 2 so as to enable the master device 2 to access the ROM 15. A chip select signal line CS0 of the encoder circuit 14 is connected to the ROM 15. For example, in the case where the master device 2 rewrites the truth table stored in the ROM 15, the master device 2 outputs a clock having a clock frequency corresponding to the operation frequency assigned to the ROM 15 (slave CS control unit 1), so as to assert the chip select signal. The chip select signal line CS0 is asserted in the encoder circuit 14 of the slave CS control unit 1, and the master device 2 rewrites the truth table stored in the ROM 15 via the data lines (SDI, SDO).

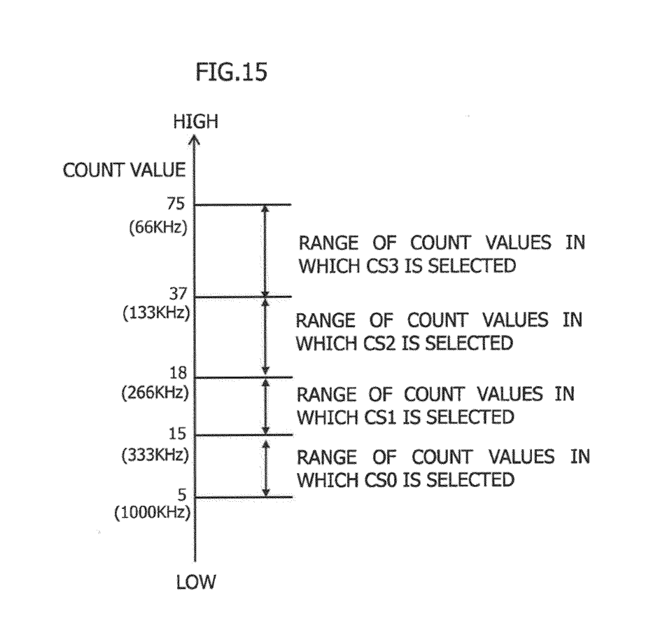

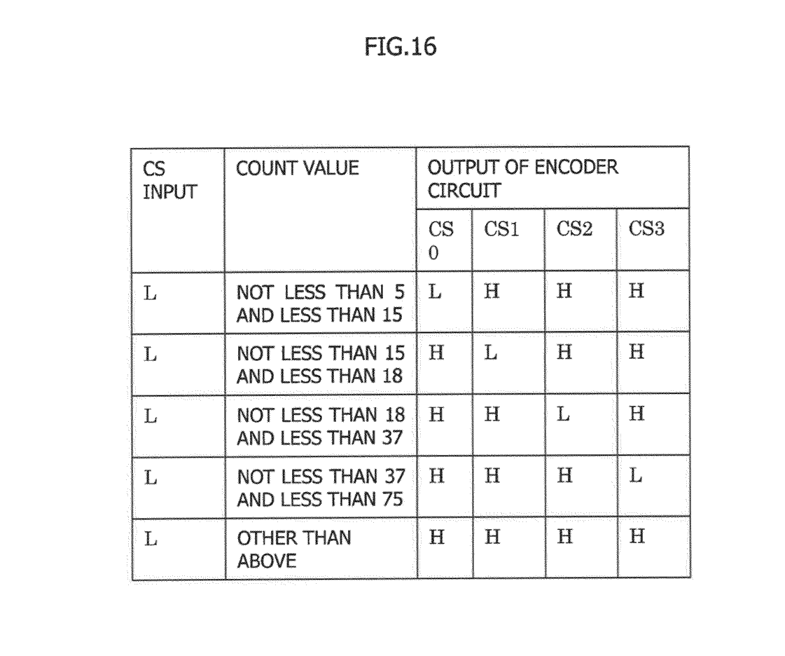

FIG. 15 illustrates an example of the ranges of count values, which ranges are respectively assigned to the chip select signal lines of the encoder circuit 14. FIG. 16 illustrates an example of a truth table for chip selection. In the truth table of FIG. 16, the chip select signal line is active when it is at L level. The truth table of FIG. 16 is stored in the ROM 15. The system configuration associated with FIG. 15 and FIG. 16 is similar to the system configuration illustrated in FIG. 10. Further, operation frequencies of the ROM 15, the slave devices 31, 32 and 33 are assumed to be set to 500 KHz, 300 KHz, 200 KHz and 100 KHz, respectively.

As illustrated in FIG. 15 and FIG. 16, in the second embodiment, a range of count values is also assigned to the chip select signal line CS0 connected to the ROM 15. The master device 2 is enabled to access the ROM 15 by setting the clock frequency thereof to the operation frequency assigned to the ROM 15. Further, when the master device 2 accesses the ROM 15, the master device 2 can change the truth table stored in the ROM 15, that is, the range of count values which is assigned to each of the chip select signal lines of the encoder circuit 14. Therefore, the configuration of the second embodiment can flexibly cope with change, addition, and the like, of the clock frequency for selection of the slave device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more the embodiments of the present invention have been described in detail, it should be understood that the various changes, substitutions, and alterations could be made hereto without departing from the spirit and scope of the invention.

What is claimed is:

1. A selection device comprising:
an interface connected to at least a clock signal line and a chip select signal line among output lines of a first device;
a plurality of interfaces respectively connected to chip select signal lines of a plurality of second devices each operated in synchronization with a clock signal of the first device;
a measuring unit that measures a clock frequency of the first device; and
a selecting unit that, according to the clock frequency of the first device measured by the measuring unit, selects a chip select signal line connected to one of the plurality of second devices, and outputs a chip select signal from the first device to the selected chip select signal line.

2. The selection device according to claim 1, further comprising
a clock operating at a frequency higher than the clock frequency of the first device,
wherein the measuring unit measures the number of clock cycles of the clock, the clock cycles being included in one clock cycle of the clock signal outputted from the first device, and
the selecting unit selects, according to the number of clock cycles, a chip select signal line connected to one of the plurality of second devices.

3. A selection method comprising:
measuring a clock frequency of a first device; and
selecting, according to the measured clock frequency of the first device, a chip select signal line connected to one of a plurality of second devices each operated in synchronization with a clock signal of the first device, and then outputting a chip select signal from the first device to the selected chip select signal line.

4. An information processing device comprising:
a first device;
a plurality of second devices each operated in synchronization with a clock signal of the first device; and
a selection device including
an interface that is connected to at least a clock signal line and a chip select signal line among output lines of the first device,
a plurality of interfaces that are respectively connected to chip select signal lines of the plurality of second devices,
a measuring unit that measures a clock frequency of the first device, and
a selecting unit that, according to the clock frequency of the first device measured by the measuring unit, selects a chip select signal line connected to one of the plurality of second devices, and outputs a chip select signal from the first device to the selected chip select signal line.
